(19) United States
(12) Patent Application Publication
(10) Pub. No.: US 2014/0028125 A1
(43) Pub. Date: Jan. 30, 2014

(54) OUTER ROTOR TYPE MOTOR

(71) Applicant: NAMIKI SEIMITSU HOUSEKI KABUSHIKI KAISHA, Tokyo (JP)

(72) Inventor: Kazuo ARAI, Tokyo (JP)

(73) Assignee: NAMIKI SEIMITSU HOUSEKI KABUSHIKI KAISHA, Tokyo (JP)

(21) Appl. No.: 14/042,479

(22) Filed: Sep. 30, 2013

Related U.S. Application Data
(63) Continuation of application No. PCT/JP2012/057259, filed on Mar. 22, 2012.

(30) Foreign Application Priority Data
Mar. 31, 2011 (JP) 2011-079649

(51) Int. Cl. H02K 1/27; H02K 9/06; H02K 9/22; H02K 5/22

(52) U.S. Cl. CPC H02K 1/2786; H02K 5/22; H02K 9/06; H02K 9/22
USPC 310/62; 310/71; 310/64

(57) ABSTRACT

To provide an outer rotor type motor configured so that the lead wires of the winding coils for the stators are routed simply. An outer rotor type motor is provided with stators arranged in the axial direction, a rotor supported so as to rotate around the stators, a drive shaft provided integrally with the rotor, winding coils respectively wound on the stators, and magnets affixed to the rotor so as to respectively correspond to the stators. The outer rotor type motor is configured so that the rotor and the drive shaft are rotated by the magnetic action between the winding coils and the magnets. A penetration portion extending in the axial direction is provided in at least one of the stators, and the lead wires of the winding coils are inserted through the penetration portion and led to the outside.

### TECHNICAL FIELD

The present invention relates to an outer rotor type motor in which a rotor rotates around the outer periphery of a stator. Specifically, the present invention relates to an outer rotor type motor preferably used as a motor of a small electric aircraft and the like.

### BACKGROUND ART

In the related art, for example, as described in Patent Document 1, this kind of invention includes a brushless motor having: a drive shaft (2); a plurality of stators (15, 16) arranged in the outer periphery of the drive shaft; a drive wheel (21) in which the central part is fixed to the outer periphery of the drive shaft and which extends in the diameter direction of the drive shaft; a plurality of cylindrical rotors (26, 27) which is fixed to the outer periphery of the drive wheel, extends in the same concentric shape as the drive shaft from the drive wheel to both sides of the drive shaft direction, and is arranged in the outer peripheries of the stators; and a plurality of bearings (33, 34) which supports the a plurality of rotors from both sides of the drive shaft in the axial direction.

According to this brushless motor, since it is possible to acquire the rotor turning effort of a plurality of stages in the axial direction, it is possible to acquire a large output even in the case of a relatively small diameter size. Moreover, since the current value of the winding coil of each stator becomes small, it is possible to thin the wire diameter of the winding coil or shorten the length of the winding coil. Furthermore, by reducing the diameter size, it is possible to increase the maximum number of rotations of the rotor. Moreover, even in a case where any of the winding coils is broken, it is possible to perform operation with other winding coils and, for example, improve the safety and reliability in the case of application as propulsion of a small electric aircraft.

The above-mentioned related art provides various advantages as described above. However, since there are provided a plurality of stators and a plurality of winding coils corresponding to the stators respectively, there is a problem that it is not possible to simplify the handling of lead wires to draw the winding coils to the outside.

More specifically, since there is the drive wheel (21) that rotates together with the drive shaft and the rotors between two adjoined stators, it is not possible to draw the winding coils (17,18) of two stators to the same direction, and thus it is necessary to extend them to one side and the other side of the axial direction, insert them to guide plates (11,12) on both sides, draw them to the outside and connect the lead wires drawn to the two directions to a power source. Thus, in the related art, handling of the lead wires is complicated.

### CITATION LIST

### Patent Document

Patent Document 1: JP-A-2009-291031

### SUMMARY OF INVENTION

### Technical Problem

The present invention is made in view of the above-mentioned conditions of the related art and the problem is to provide an outer rotor type motor that can simplify the handling of lead wires of winding coils in a plurality of stators.

### Solution to Problem

The technical means to solve the above-mentioned problem provides an outer rotor type motor including a plurality of stators arranged in an axial direction, a rotor supported so as to be rotatable around the plurality of stators, a drive shaft integrally installed in the rotor, a winding coil wound for each of the stators and a magnet fixed to the rotor, in which the rotor and the drive shaft are rotated by magnetic action between the winding coil and the magnet. A penetration portion extending in the axial direction is installed in at least one of the plurality of stators and a lead wire of the winding coil is inserted to the penetration portion and led outside.

Further, in specific means to simplify the handling of the lead wire, a rigid support member that fixedly supports the plurality of stators in an unrotatable manner from one end side of the axial direction and supports the rotor in a rotatable manner is installed, a penetration portion that extends in the axial direction is installed in the rigid support member, and the lead wire is drawn from the penetration portion.

Further, in preferable means to simplify the handling of the lead wire, a rotation support member that rotates around the plurality of stators is installed on the other end side of the axial direction as compared with the plurality of stators, the rotor is fixedly supported to an outer periphery of the rotation support member, and the drive shaft is fixedly supported to a central side of the rotation support member.

Here, the other end side means the reverse end side to the one end side, in other words, the opposite side to the rigid support member side in the stator axial direction.

Moreover, as means to effectively cool the outer rotor type motor, a ventilation wing is installed in the rotation support member and air around the stator is flowed by the ventilation wing.

Moreover, as means to keep good manufacturability, maintenance and the like of the outer rotor type motor, the plurality of stators and the rigid support member are formed in a substantially convex shape, the rotor and the rotation support member are formed in a substantially concave shape, and these are combined in the axial direction.

Moreover, as means to maintain the stiffness property of the rotor of the outer rotor type motor, arrange more stators in the axial direction, and enable improvement of an output, the plurality of stators is arranged across a drive wheel fixed to the drive shaft and the rotor.

Moreover, as means to effectively radiate heat of the outer rotor type motor, a thermal conductivity member is installed such that one end side is inserted to the penetration portion of the stator and the other end side is positioned at least outside the stator.

Here, the technical means including the thermal conductivity member can excellently provide a radiation effect even as an independent invention without components of the technical means described above.

That is, the outer rotor type motor of this independent invention includes a plurality of stators arranged in an axial direction, a rotor supported so as to be rotatable around the plurality of stators, a drive shaft integrally installed in the rotor, a winding coil wound for each of the stators and a magnet fixed to the rotor, in which the rotor and the drive shaft are rotated by magnetic action between the winding coil and the magnet. A penetration portion extending in the axial direction is installed in at least one of the plurality of stators and a thermal conductivity member is installed such that one end side is inserted to the penetration portion and the other end side is positioned at least outside the stator.

Incidentally, although the other end side of the thermal conductivity member may be positioned at least outside the stator, it is more preferred that it is inserted to a penetration portion of the rigid support member and positioned outside the outer rotor type motor.

### Advantageous Effects of Invention

The present invention is made as described above and therefore provides an advantageous effect described as follows. By inserting a plurality of lead wires installed in association with a plurality of stators to penetration portions of the stators, it is possible to lead them to only one side of the axial direction and draw them to the outside.

Therefore, it is possible to simplify the handling of lead wires of wiring coils in a plurality of stators without impairing various advantages of an outer rotor type motor that a large output can be obtained even in the case of a relatively small diameter size, a wiring coil can be thinned and shortened, the maximum number of rotations can be increased by reduction of the diameter size, and the reliability can be improved.

### BRIEF DESCRIPTION OF DRAWINGS

FIG. 1 is an internal structure diagram illustrating one example of an outer rotor type motor according to the present invention.

FIG. 2 is a cross-sectional view illustrating one example of a stator.

FIG. 3 is a plan view illustrating one example of a rigid support member.

FIG. 4 is a plan view illustrating one example of a rotation support member.

FIG. 5 is an internal structure diagram illustrating one example of an outer rotor type motor according to the present invention.

FIG. 6 is an internal structure diagram illustrating one example of an outer rotor type motor according to the present invention.

### DESCRIPTION OF EMBODIMENTS

An embodiment of the present invention is described based on the drawings. Also, in the following explanation, the “axial direction” means the direction of the center axis of a stator, rotor or drive shaft. Moreover, the “radial direction” means the direction orthogonal to the above-mentioned axial direction.

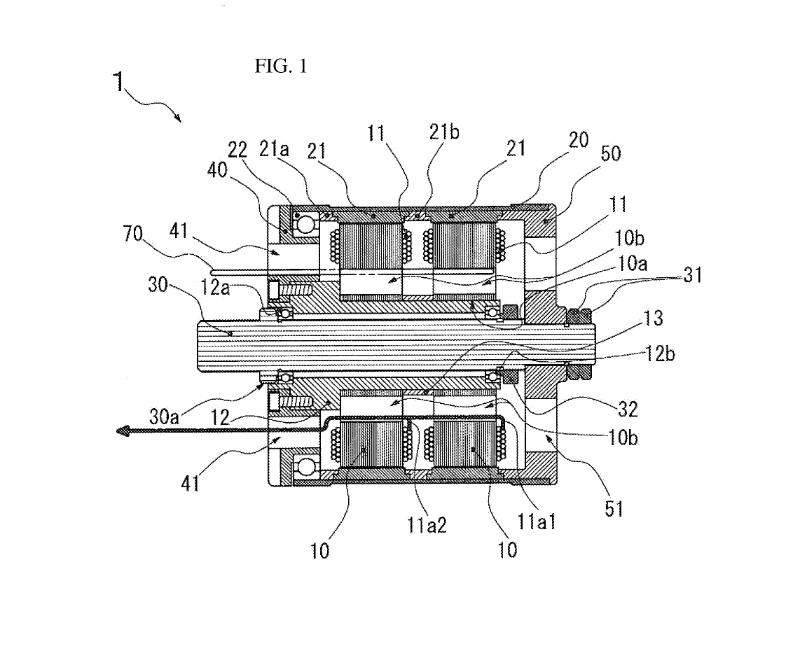

FIG. 1 illustrates one example of an outer rotor type motor according to the present invention. This outer rotor type motor 1 includes a plurality of stators 10 arranged in the axial direction, a rotor 20 that is supported so as to rotate around the plurality of stators 10, a drive shaft 30 that is integrally installed with the rotor 20, a winding coil 11 wound for each of the stators 10, a magnet 21 fixed to the rotor 20 in association with each of the stators 10, a rigid support member 40 that fixedly supports the plurality of stators in an unrotatable manner from one end side of the axial direction, and a rotation support member 50 that rotates with respect to the plurality of stators 10 and fixedly supports the rotor 20. The rotor 20, the rotation support member 50, and the drive shaft 30 are rotated by the magnetic action between the winding coil 11 and the magnet 21.

Moreover, this outer rotor type motor 1 has a penetration portion 10b extending in the axial direction in at least one (according to the illustrated example, all) of the plurality of stators 10, such that lead wires 11a1 and 11a2 of the winding coil 11 are inserted to the penetration portion 10b and led to the outside.

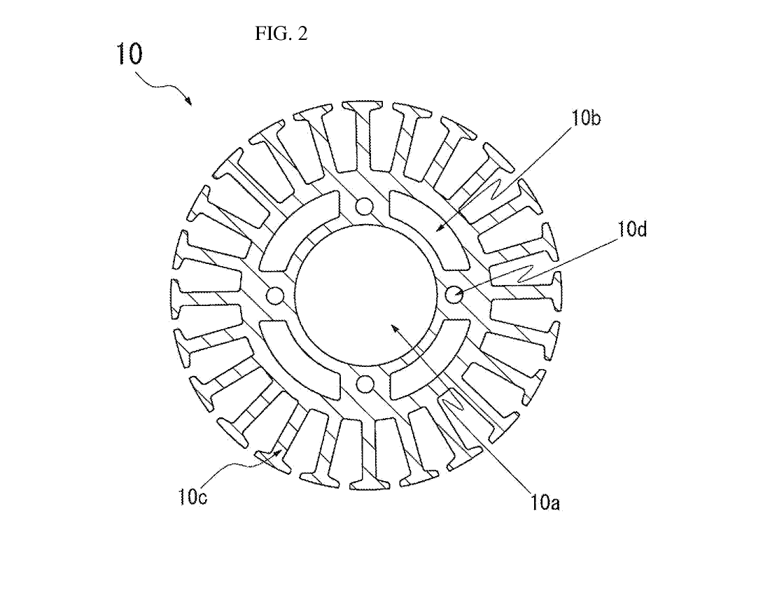

Each of the stators 10 is formed in a substantially cylindrical shape by mutually isolating multiple laminar magnetic materials (such as a silicon steel plate) and laminating them in the axial direction, includes a consecutive large-diameter through-hole 10a in the axial direction with respect to the central part, and includes a through-hole 10b to insert the lead wires 11a1 and 11a2 to a position slightly apart from the large-diameter through-hole 10a on the outer side (see FIGS. 1 and 2).

Moreover, on the further outer side than the penetration portion 10b of this stator 10, many items of the teeth portion 10c to roll the winding coil 11 are placed at intervals in the circumferential direction (see FIG. 2).

The penetration portion 10b is a hole that penetrates to the axial direction of the stator 10 in a linear fashion, and is arranged nearer to the central part than the winding coil 11 in the stator 10 (in other words, nearer to the central part than the teeth portion 10c).

Here, as another example of this penetration portion 10b, it is possible to provide a groove (not illustrated) extended to the axial direction in the inner periphery of the large-diameter through-hole 10a. These penetration portions 10b are installed at equal intervals in the circumferential direction of the stator 10. Although the number of these penetrations 10b is not especially limited, for example, it may be placed four times at angular intervals of 90 degrees (see FIG. 2) or it may be placed three times at angular intervals of 120 degrees (not illustrated).

Moreover, it is preferable to make the position of the penetration portion 10b in the stator radial direction nearer to the center of the stator 10 as illustrated in the same figure in order to avoid as much as possible to have harmful effects on the formation of a magnetic path in stator 10.

Multiple items (according to the illustrate example, two) of the stator 10 of the above-mentioned configuration are installed at an interval on the axial direction as illustrated in FIG. 1. The interval between the adjacent stators 10 is maintained to a predetermined interval through the intervention of an annular spacer 13. Moreover, in FIG. 2, a reference numeral of 10d represents a through-hole to insert a bolt that couples the plurality of stators 10.

Subsequently, the plurality of stators 10 is fixed in an unrotatable manner to a spindle case 12 inserted to the large-diameter through-hole 10a on the center side.

The spindle case 12 is a substantially cylindrical shaped member inserted to the central part of the plurality of stators 10, includes a portion that projects to one end side (which is the left end side according to FIG. 1) of the plurality of stators 10, and fixes the rigid support member 40 to the outer periphery of the projection.

Moreover, in the inner periphery of this spindle case 12, the drive shaft 30 is supported in a rotatable manner through a plurality of (according to the illustrated example, 2) bearings 12a and 12b on the both end sides of the axial direction.

Also, the rotor 20 is a thin cylindrical shaped member arranged so as to cover the periphery of the plurality of stators 10, where one end part (which is the left end part in FIG. 1) is supported in a rotatable manner with respect to the outer peripheral part of the rigid support member 40 through the bearing 22 and the other end part is connected and fixed to the rotation support member 50.

The magnet 21 (permanent magnet) is provided on the inner periphery of the rotor 20 by a predetermined air gap from the outer periphery of the stator 10. Multiple items of this magnet 21 are set in the axial direction at the same pitch as the plurality of stators 10 so as to correspond to the plurality of stators 10.

The plurality of magnets 21 is fitted in a concavo-convex manner to annular brackets 21a and 21b fixed to the inner periphery of the rotor 20 and the outer peripheral part of the rotation support member 50, and is therefore fixed to the rotor 20 integrally.

Moreover, the drive shaft 30 is supported in a rotatable manner in the spindle case 12, where the one end side (which is the left end side according to FIG. 1) projects from the rigid support member 40 to the outside and the other end side is inserted to the central part of the rotation support member 50 to fix and support the rotation support member 50. For example, in a small electric aircraft, a propeller (not illustrated) is fixedly supported to the projection on the above-mentioned one end side of the drive shaft 30.

Moreover, on the above-mentioned one end side of the drive shaft 30, an annular protrusion 30a is installed. This annular projection 30a is in contiguity or touch with one bearing 12a that supports the spindle case 12 in a rotatable manner, from one side (which is the left side according to FIG. 1) in the axial direction.

Moreover, on the other end side (which is the right end side according to FIG. 1) of the drive shaft 30, a stopper ring 32 is annularly attached and fixed between the spindle case 12 and the rotation support member 50. This stopper ring 32 is in contiguity or touch with the other bearing 12b that supports the spindle case 12 in a rotatable manner, from the other side (which is the direction side according to FIG. 1).

Therefore, the spindle case 12 is sandwiched between the annular projection 30a and the stopper ring 32, and retained so as to become immovable in the axial direction.

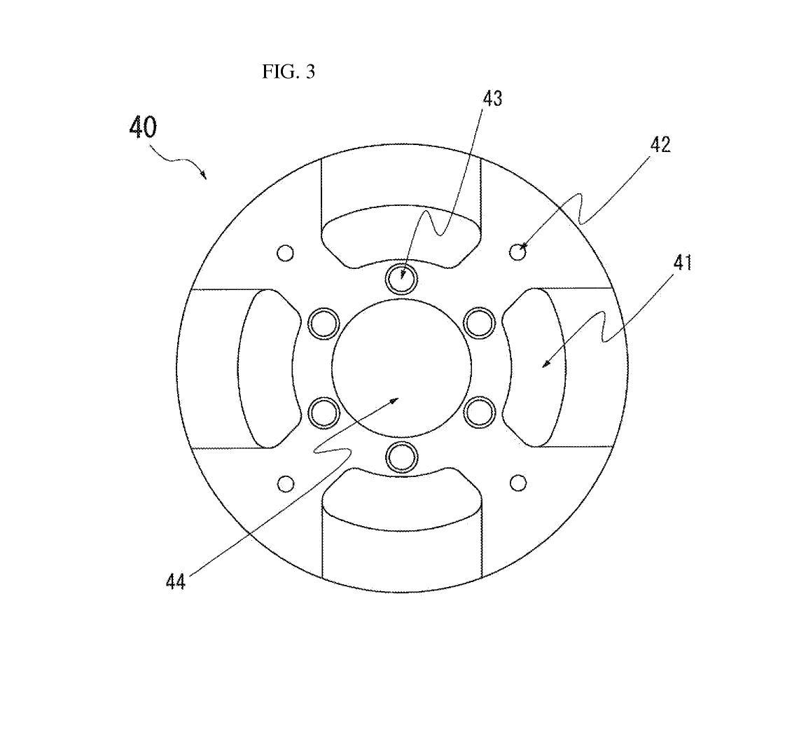

Moreover, the rigid support member 40 is substantially a thick cylindrical shaped member fixed so as to extend from the outer periphery on the above-mentioned one end side (which is the left end side according to one example of FIG. 1) of the spindle case 12 to the radial direction (see FIG. 1 and FIG. 3). This rigid support member 40 is fixed in an unrotatable manner to an immovable base which is not illustrated and the like.

In this rigid support member 40, as illustrated in FIG. 3, a plurality of penetration portions 41 is installed at intervals in the circumferential direction. These penetration portions 41 are installed in the circumferential direction so as to correspond to the penetration portions 10b of the stator 10, and, according to the illustrated example, four items are installed at angular intervals of 90 degrees.

Although each of the penetration portions 41 is a through-hole that penetrates the rigid support member 40 along the axial direction in the illustrated example, as another example, it is possible to provide a groove that opens the inner periphery of the rigid support member 40 and extends in the axial direction.

The outside diameter size of this rigid support member 40 is set to be slightly larger than the outside diameter size of the stator 10 and substantially the same outside diameter size than the outside diameter size of the rotor 20. According to such a size setting, the plurality of stators 10 and the rigid support member 40 are formed in a substantially convex shape as illustrated in FIG. 1 and the plurality of stators 10 of the convex-shaped parts exist inside the rotor 20.

Here, in FIG. 3, reference numerals of 42 represent a plurality of screw holes to fix the rigid support member 40 to an immovable base which is not illustrated and the like. A reference numeral of 43 represents a fixing hole to pass through a fixing tool such as a bolt and fix the rigid support member 40 to the spindle case 12, and a reference numeral of 44 represents an engagement hole fitted to one end side of the spindle case 12.

Moreover, as illustrated in FIG. 1, the rotation support member 50 is annularly attached to a part subjected to diameter reduction in a stepped manner on the other end side (which is the right end side according to the illustrated example) of the drive shaft 30 and fixed in an unrotatable manner through a key member (not illustrated). This rotation support member 50 is maintained so as not to be removed to the outside in the axial direction by a plurality of (according to the illustrated example, two) thrust nuts 31 which is further fixed to the above-mentioned other end side of the drive shaft 30.

As illustrated in FIG. 1, this rotation support member 50 and the rotor 20 are formed in a substantially concave shape and fitted to the rigid support member 40 and the stator 10 which have a substantially convex shape.

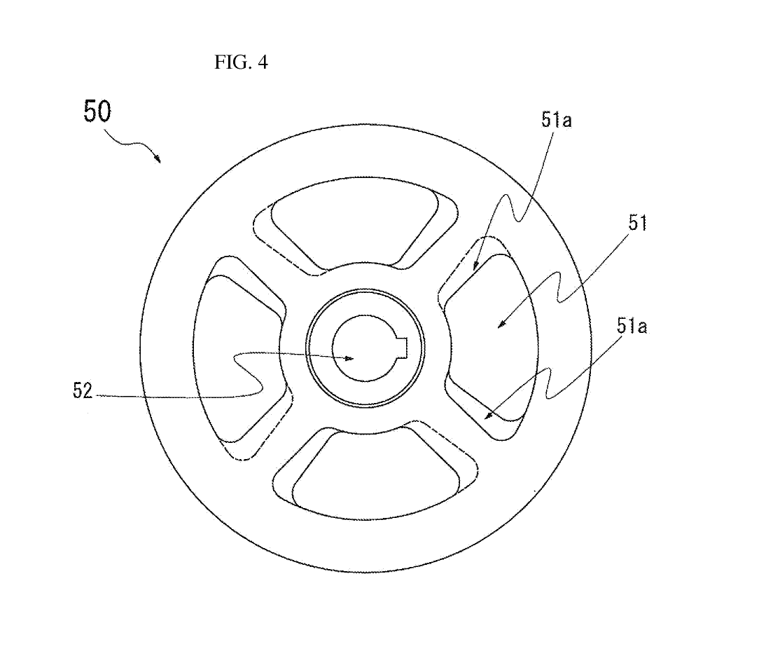

Subsequently, as illustrated in FIG. 4, an insertion through-hole 52 to insert the drive shaft 30 is installed in the rotation support member 50 and a plurality of through-holes 51 is installed at intervals in the circumferential direction in the periphery of the insertion through-hole 52.

Each of the through-holes 51 is a substantially arc-like shaped hole along the circumferential direction of the rotation support member 50, and, in the inner periphery of the circumferential direction, a ventilation wing 51a is installed so as to flow the gas (such as air) in the space surrounding the stator 10. This ventilation wing 51a is formed by processing a curved surface or tilted surface to the above-mentioned inner periphery. The tilt direction of this tilted surface is assumed to be a direction in which air is taken in or a direction in which internal air is emitted to the outside, according to the usage and the like of the outer rotor type motor 1.

Moreover, the winding coil 11 is wound around the plurality of teeth portions 10c (see FIG. 2) of the stator 10 of the above-mentioned structure. Subsequently, the lead wires 11a1 and 11a2 of the winding coil 11 are inserted to the penetration portion 10b of the stator 10 and led to the outside.

If the illustrated example is described in more detail, as illustrated in FIG. 1, the lead wire 11a1 of the winding coil 11 in the stator 10 on one side (which is the right side in the figure) is inserted to the penetration portion 10b of this stator 10, caused to join the lead wire 11a2 of the winding coil 11 in the stator 10 on the other side (which is the left side in the figure), inserted to the penetration portion 10b of the stator 10 on the other side (or the left side in the figure), further inserted to the penetration portion 41 of the rigid support member 40 and led to the outside.

In the illustrated example, although the lead wires 11a1 and 11a2 are joined in the penetration portion 10b of the stator 10 on the other side (or the left side in the figure), the lead wire 11a2 may be drawn from the side of the rigid support member 40 such that the lead wires 11a1 and 11a2 are joined in the penetration portion 41 of the rigid support member 40 without passing though the penetration portion 10b.

Here, the junction of the lead wires in this example shows the handling of the lead wires and necessarily means neither a state in which the lead wires are completely contacted with each other nor an electric connection.

Here, the plurality of winding coils 11 is series-connected or parallel-connected by wire connection of the lead wires 11a1 and 11a2. Whether the plurality of winding coils 11 is serial-connected or they are parallel-connected is arbitrarily selected according to the usage or control method of the outer rotor type motor 1.

Moreover, a thermal conductivity member 70 is optionally inserted in the penetration portion 10b of the stator 10. This thermal conductivity member 70 is set such that one end side is inserted in the above-mentioned penetration portion 10b and the other end side is located at least outside the stator 10 (or outside the outer rotor type motor 1 according to the illustrated example) for radiation of the stator 10.

The material of this thermal conductivity member 70 is assumed to be a material of a comparatively high heat transfer coefficient (for example, copper, aluminum, thermal conductivity silicon and the like). This thermal conductivity member 70 is formed in a plate shape as a preferable shape to improve the radiation performance especially. Moreover, a heat pipe of a known structure is used as another preferred aspect of this thermal conductivity member 70.

According to the outer rotor type motor 1 of the above-mentioned structure, the lead wires 11a1 and 11a2 in the plurality of stators 10 can be passed through the penetration portions 10b of the stators 10 and the penetration portions 41 of the rigid support member 40, led to one direction and drawn to the outside, and therefore it is possible to simplify the handling, wiring and the like of the lead wires 11a1 and 11a2 in the plurality of stators 10.

Subsequently, since the handling, wiring and the like of the lead wires 11a1 and 11a2 can be simplified in this way, it is easy to increase the number of stators 10 arranged in the axial direction to around 4 to 5 and further improve an output.

Moreover, since the rotation support member 50 that supports the rotor 20 is arranged on the edge side in the axial direction, it is not necessary to set a rotation support member (e.g., drive wheel) between adjacent stators unlike the related art, and therefore it is possible to reduce the total weight of the outer rotor type motor 1.

Moreover, the plurality of stators 10 and the rigid support member 40 are formed in a substantially convex shape, the rotor 20 and the rotation support member 50 are formed in a substantially concave shape and these are fitted in a convexo-concave shape in the axial direction, and therefore good productivity, easy decomposition and excellent maintenance are provided.

Moreover, effective radiation is possible by the thermal conductivity member 70 inserted to the penetration portion 10b of the stator 10 and the penetration portion 41 of the rigid support member 40.

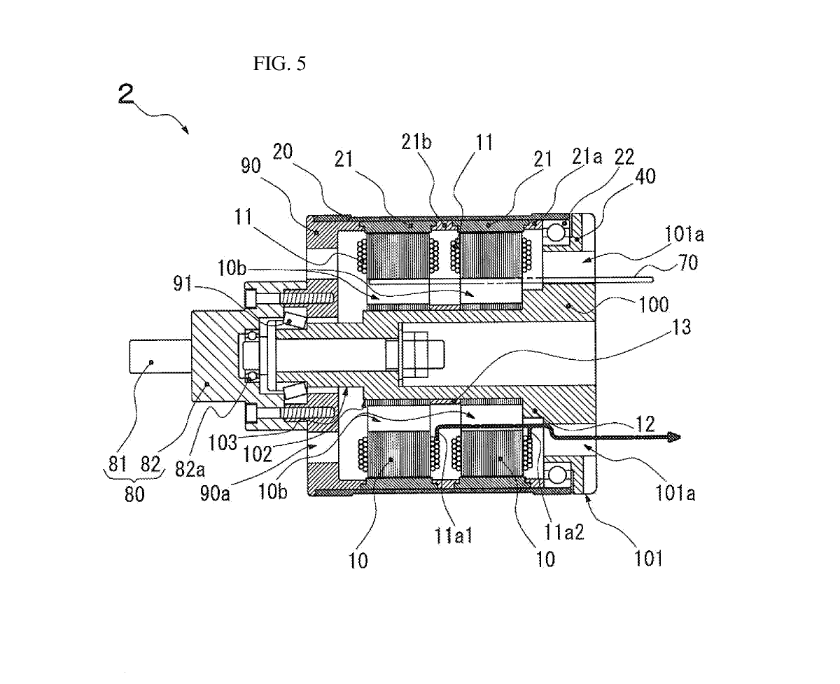

Next, an outer rotor type motor 2 illustrated in FIG. 5 is described. Since this outer rotor type motor 2 is made by changing part of the outer rotor type motor 1, the change part is chiefly described in detail. Moreover, the same reference numerals are assigned to the substantially similar parts to the outer rotor type motor 1 and overlapping specific explanation is omitted.

As illustrated in FIG. 5, this outer rotor type motor 2 includes the plurality of stators 10 arranged in the axial direction, the rotor 20 that is supported so as to rotate around the plurality of stators 10, a drive shaft 80 that is integrally installed with the rotor 20, the winding coil 11 wound for each of the stators 10, the magnet 21 fixed to the rotor 20 in association with each of the stators 10, a rotation support member 90 that rotates around the plurality of stators 10 and a rigid support member 100 that fixedly supports the plurality of stators in an unrotatable manner from one end side of the axial direction, where the rotor 10, the rotation support member 90 and the drive shaft 80 are rotated by the magnetic action between the winding coil 11 and the magnet 21.

Moreover, this outer rotor type motor 2 has the penetration portion 10b extending in the axial direction in at least one (according to the illustrated example, all) of the plurality of stators 10, such that the lead wires 11a1 and 11a2 of the winding coil 11 are inserted to the penetration portion 10b and led to the outside.

The drive shaft 80 is integrally formed with a shaft body portion 81 and a connection portion 82 that connects the shaft body portion 81 to the rotation support member 90.

The shaft body portion 81 is an axis-shaped member that projects from the central part of the rotor 20 to one direction (which is the left direction according to FIG. 5). For example, in a small electric aircraft, a propeller and the like is fixed to this shaft body portion 81.

The connection portion 82 is a laterally concave member, which is supported in a rotatable manner by the rigid support member 100 through a bearing 82a and connected and fixed around the center of the rotation support member 90 by a fixing tool (such as a bolt and a screw).

As illustrated in FIG. 5, the rotation support member 90 is annularly attached to a part on one end side (which is the left end side according to the illustrated example) of the rigid support member 100 and maintained so as to be rotatable with respect to the rigid support member 100 and so as not to be apart from the rigid support member 100 in the axial direction, by using a conical roller bearing 91 on the center side.

The outer periphery of the rotation support member 90 is connected and fixed to one end side of the rotor 20. Moreover, similar to the above-mentioned rotation support member 50, multiple items of through-hole 90a having a ventilation wing (not illustrated) are installed at intervals in the circumferential direction in this rotation support member 90. Subsequently, the rotor 20 and the above-mentioned rotation support member 90 are formed in a substantially concave shape.

Moreover, the rigid support member 100 includes a support disk portion 101 that supports the rotor 20 in a rotatable manner, a stator support protrusion 102 that projects from the center side of the support disk 101 to the above-mentioned one end side and supports the plurality of stators 10, and a rotation axis portion 103 that projects to the above-mentioned one end side more than the stator support protrusion 102 and supports the rotation support member 90 in a rotatable manner (see FIG. 5).

Similar to the above-mentioned rigid support member 40, the support disk portion 101 has a plurality of through-holes 101a to insert the lead wires 11a1 and 11a2 and the thermal conductivity member 70. Moreover, the rotor 20 is supported in a rotatable manner to the outer periphery of this stator 10 through the bearing 22.

The stator support protrusion 102 protrudes from the central part of the support disk 101 to one end side (which is the left end side according to FIG. 5) in a substantially cylindrical shape. A plurality of (according to the illustrated example, two) stators 10 is fixed at a predetermined interval in the axial direction to the outer periphery of this stator support protrusion 102.

Moreover, the rotation axis portion 103 is formed in a cylindrical shape subjected to slight diameter reduction as compared with the stator support protrusion 102. This rotation axis portion 103 supports the rotation support member 90 so as to be rotatable and so as not to be removed in the axial direction, through the conical roller bearing 91 in the outer peripheral. Moreover, this rotation axis portion 103 supports the drive shaft 80 in a rotatable manner by using the bearing 82a in the most projecting end part of an axis-shaped member 103a that projects from the front edge.

Moreover, the plurality of stators 10 and the rigid support member 100 are formed in a substantially convex shape to fit the substantially-concave rotation support member 90 and rotor 20.

Moreover, as illustrated in FIG. 5, the lead wire 11a1 of the winding coil 11 in the stator 10 on one side (which is the left side according to the illustrated example) is inserted to the penetration portion 10b of the stator 10 on the other side (which is the right side according to the illustrated example), further caused to join the lead wire 11a2 of the winding coil 11 in the stator 10 on the other side, and inserted to a through-hole 101a of the rigid support member 100 and led to the outside.

Moreover, the thermal conductivity member 70 is set such that one end side is inserted in the above-mentioned penetration portion 10b and the other end side is located at least outside the stator 10 (or outside the rigid support member 100 according to the illustrated example) for radiation of the stator 10.

Therefore, according to the outer rotor type motor 2 illustrated in FIG. 5, similar to the above-mentioned outer rotor type motor 1, it is possible to simplify the handling or wiring of the lead wires 11a1 and 11a2 in the plurality of stators 10, and it is possible to increase the number of the stators 10 arranged in the axial direction to, for example, around 4 to 5 and easily improve an output.

Moreover, since a structure is adopted in which the rigid support member 100 supports the edge side of the rotor 20, it is not necessary to set a rotation support member (e.g., drive wheel) between adjacent stators unlike the related art, and therefore it is possible to reduce the total weight of the outer rotor type motor 2.

Moreover, the plurality of stators 10 and the rigid support member 100 are formed in a substantially convex shape, the rotor 20 and the rotation support member 50 are formed in a substantially concave shape and these are fitted in a convexo-concave shape in the axial direction, and therefore good productivity, easy decomposition and excellent maintenance are provided.

Moreover, effective radiation is possible by the thermal conductivity member 70 inserted to the penetration portion 10b of the stator 10 and the penetration portion 101a of the rigid support member 100.

Here, according to the outer rotor type motor (1 or 2) of the illustrated example, although the thermal conductivity member 70 is installed in the penetration portion 10b (which is the upper penetration portion 10b according to FIG. 1 or FIG. 5) different from the penetration portion 10b to which the lead wires 11a1 and 11a2 are inserted, as another example, it may be installed in the penetration portion 10b (which is the lower penetration portion 10b according to FIG. 1 or FIG. 5) to which the lead wires 11a1 and 11a2 are inserted, together with these lead wires.

Moreover, as another preferred aspect, the stator 10 may be reinforced by stubbornly fixing the thermal conductivity member 70 to the plurality of stators 10 and the rigid support member (40 or 100).

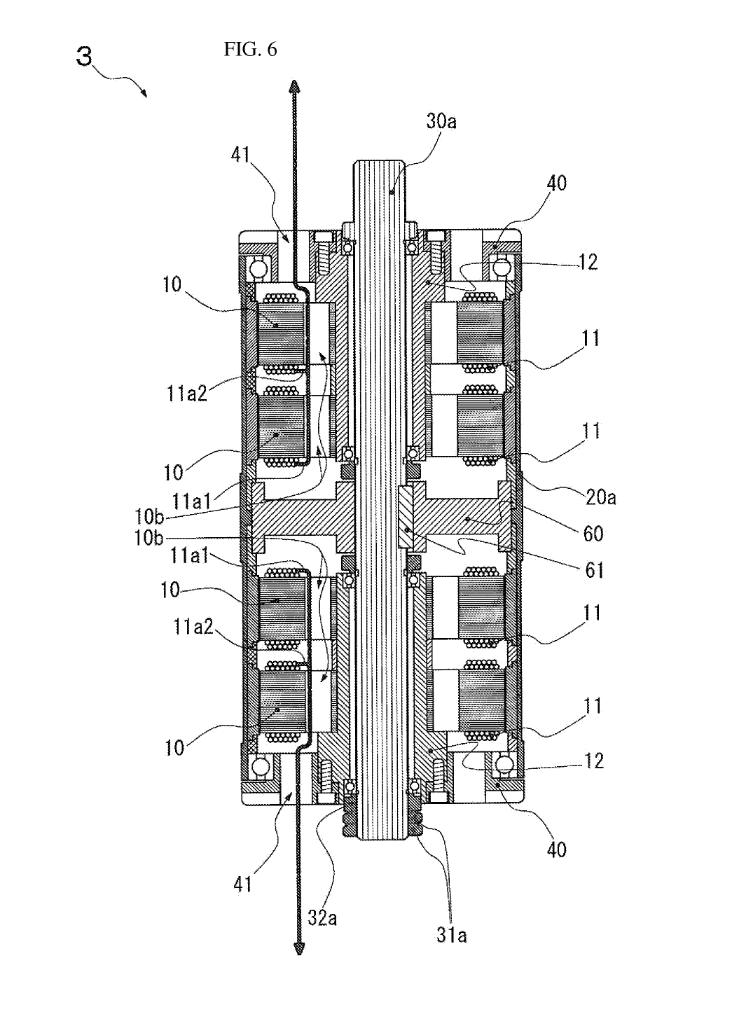

Next, an outer rotor type motor 3 illustrated in FIG. 6 is described. Since this outer rotor type motor 3 is made by changing part of the outer rotor type motor 1, the change part is chiefly described in detail. Moreover, specific explanation of the substantially similar parts to the outer rotor type motor 1 is omitted.

As illustrated in FIG. 6, the outer rotor type motor 3 includes a drive wheel 60 that extends in the radial direction of the drive shaft 30a.

This drive wheel 60 is fixed through a key block 61 fitted to a key groove installed in part of the outer peripheral of the drive shaft 30a in the central part (in this example, although it is fixed by the key block, for example, it is possible to fix the drive wheel to the drive shaft by various fixation methods such as “fixation by spline” and “fixation by setscrew”).

Moreover, the drive wheel 60 is fixed to the outer periphery of the rotor 20a. This drive wheel 60 functions as well as the rotation support member 50 (FIG. 1) in the outer rotor type motor 1 (FIG. 1) and integrally rotates with the drive shaft 30a and the rotor 20a.

The spindle cases 12 are arranged in a symmetrical position relationship across the drive wheel 60 in the axial direction. Moreover, the rigid support member 40 is fixed to the outer periphery of the projection of each of the spindle cases 12.

In each of the spindle cases 12, the plurality of stators 10 is arranged in the axial direction (on the illustration of FIG. 6, two stators 10 are arranged above the drive wheel 60 and two stators 10 are arranged below the drive wheel 60).

Moreover, in one end (which is the lower side according to FIG. 6) of the drive shaft 30a, one stopper ring 32a and two thrust nuts 31a are arranged.

The lead wires 11a1 and 11a2 of each winding coil 11 wound around the teeth portion for each stator 10 are inserted to the penetration portion 10b of the stator 10 and led to the outside.

When the illustrated example is described in more detail, as illustrated in FIG. 6, the lead wire 11a1 of the winding coil 11 in the stator 10 on one side (which is the side of the drive wheel 60) out of two stators 10 arranged in the spindle case 12 on one side (which is the upper side in the figure) is inserted to the penetration portion 10b of this stator 10, caused to join the lead wire 11a2 of the winding coil 11 in the stator 10 on the other side (which is the upper side in the figure), inserted to the penetration portion 10b of the stator 10 on the other side (which is the upper side in the figure), and further inserted to the penetration portion 41 of the rigid support member 40 (on the upper side in the figure) and led to the outside.

Similarly, the lead wire 11a1 of the winding coil 11 in the stator 10 on the other side (which is the side of the drive wheel 60) out of the two stators arranged in the spindle case 12 on the other side (which is the lower side in the figure) is inserted to the penetration portion 10b of this stator 10, caused to join the lead wire 11a2 of the winding coil 11 in the stator 10 on the other side (which is the lower side in the figure), inserted to the penetration portion 10b of the stator 10 on the other side (which is the lower side in the figure), and further inserted to the penetration portion 41 of the rigid support member 40 (on the lower side in the figure) and led to the outside.

That is, it can say that the outer rotor type motor 3 has a format in which two outer rotor type motors 1 (FIG. 1) are arranged while sharing the drive shaft, the rotation support member (e.g., drive wheel) and the rotor.

According to this outer rotor type motor 3, since it is possible to secure the stiffness property of the rotor and suppress the shaking in the radial direction by arranging the drive wheel 60, it is possible to easily increase the number of stators 10 arranged in the axial direction in a stable state.

For example, by arranging about 4 or 5 stators on both sides across the drive wheel 60 and arranging about ten stators in total, it is possible to further improve an output.

Moreover, according to the outer rotor type motor (1, 2 or 3) of the illustrated example, although the penetration portion 10b is installed in all of the plurality of stators 10, as another example, it is possible to adopt a structure in which the penetration portion 10b for lead wire insertion is omitted with respect to the stator 10 (for example, the stator 10 on the left side in FIG. 5) to which a lead wire is not inserted.

Moreover, in the illustrated example, the rotational positions of the rotor and the drive shaft may be detected by a sensor such as a Hall element or may be detected on the basis of the midpoint potential of the winding coil.

Moreover, although the illustrated example shows a brushless-type outer rotor type motor, as another example, it is possible to form a brush-attached-type outer rotor type motor.

### DESCRIPTION OF REFERENCE SIGNS

1, 2, 3: Outer rotor type motor
10: Stator
10b: Penetration portion
11: Winding coil
11a1, 11a2: Lead wire
20, 20a: Rotor
21: Magnet
30, 30a, 80: Drive shaft
40, 100: Rigid support member
41: Penetration portion
50, 90: Rotation support member
51: Through-hole
51a: Ventilation wing
60: Drive wheel
70: Thermal conductivity member

1. An outer rotor type motor comprising:
a plurality of stators arranged in an axial direction;
a rotor supported so as to be rotatable around the plurality of stators;
a drive shaft integrally installed in the rotor;
a winding coil wound for each of the stators; and
a magnet fixed to the rotor, wherein
the rotor and the drive shaft are rotated by magnetic action between the winding coil and the magnet, and
a penetration portion extending in the axial direction is installed in at least one of the plurality of stators and a lead wire of the winding coil is inserted to the penetration portion (or the penetration portion installed in the stator) and led outside.

2. The outer rotor type motor according to claim 1, wherein
a rigid support member that fixedly supports the plurality of stators in an unrotatable manner from one end side of the axial direction and supports the rotor in a rotatable manner is installed,
a penetration portion that extends in the axial direction is installed in the rigid support member, and
the lead wire is drawn from the penetration portion (or the penetration portion installed in the rigid support member).

3. The outer rotor type motor according to claim 1, wherein
a rotation support member that rotates around the plurality of stators is installed on the other end side of the axial direction as compared with the plurality of stators,
the rotor is fixedly supported to an outer periphery of the rotation support member, and
the drive shaft is fixedly supported to a central side of the rotation support member.

4. The outer rotor type motor according to claim 2, wherein
a rotation support member that rotates around the plurality of stators is installed on the other end side of the axial direction as compared with the plurality of stators,
the rotor is fixedly supported to an outer periphery of the rotation support member, and
the drive shaft is fixedly supported to a central side of the rotation support member.

5. The outer rotor type motor according to claim 3, wherein
a ventilation wing is installed in the rotation support member, and
air around the stator is flowed by the ventilation wing.

6. The outer rotor type motor according to claim 3, wherein
the plurality of stators and the rigid support member are formed in a substantially convex shape,
the rotor and the rotation support member are formed in a substantially concave shape, and
these are combined in the axial direction.

7. The outer rotor type motor according to claim 1, wherein the plurality of stators is arranged across a drive wheel fixed to the drive shaft and the rotor.

8. The outer rotor type motor according to claim 2, wherein the plurality of stators is arranged across a drive wheel fixed to the drive shaft and the rotor.

9. The outer rotor type motor according to claim 1, wherein a thermal conductivity member is installed such that one end side is inserted to the penetration portion of the stator and the other end side is positioned at least outside the stator.

10. The outer rotor type motor according to claim 2, wherein a thermal conductivity member is installed such that one end side is inserted to the penetration portion of the stator and the other end side is positioned at least outside the stator.
